(19) United States
(12) Patent Application Publication
(10) Pub. No.: US 2004/0046138 A1
(43) Pub. Date: Mar. 11, 2004

(54) Control valve for liquids

(76) Inventors: Juergen Stein, Illingen (DE); Michael Huebel, Gerlingen (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/332,821

(22) PCT Filed: May 10, 2002
(86) PCT No.: PCT/DE02/01703

(30) Foreign Application Priority Data
May 12, 2001 (DE) 101 23 218.7

(51) Int. Cl. F16K 31/02

(52) U.S. Cl. 251/129.06; 251/284

(57) ABSTRACT

The current invention relates to a valve (1) for controlling fluids, which has a piezoelectric actuator for actuating a valve element (3, 4), wherein the valve element (3, 4) moves out of a valve body (16) when actuated. A stroke control is embodied between the piezoelectric actuator and the valve element (3 ,4). The valve also has a stop device (8) for limiting the stroke h₁ of the valve element (3, 4).

### PRIOR ART

The current invention relates to a valve for metering or controlling fluid flows or fluids and in particular a fuel injection valve for a reservoir injection system.

Valves for controlling fluids are known in various embodiments. For example, DE 43 32 124 A1 has disclosed a fuel injection valve, which has an adjustable stroke limitation for a valve needle. The stroke limitation includes an actuator and a limitation stop, which is guided so that it can move in a guide bore of the fuel injection valve. The actuator is disposed on the stroke limitation in such a way that the position of the stroke limitation is determined through activation of the actuator. Consequently, a valve needle stroke can be changed in a range of approx. 0.1 mm.

An adjustable stroke limitation is also known, which is comprised of a ring, which is disposed around the valve needle and has a slot extending through it. This through slot has an actuator disposed in it, which lengthens when activated so that the stroke limitation is clamped at a particular position in a guide bore. This permits a limiting stop to be produced, which permits a stroke adjustment over a very large range.

The stroke limitations that can be adjusted by means of piezoelectric actuators can in fact be individually adjusted during operation of the valve, but their design is relatively complex. Valves are also known that open toward the outside, i.e. valves whose valve element moves out of the valve housing when actuated, but these valves do not have stroke stops. During operation, however, temperature influences can cause different elongations of the components, which can result in different injection quantities, jet angles, and penetration, particularly in outwardly opening valves.

### ADVANTAGES OF THE INVENTION

The valve according to the invention for metering or controlling fluid flows or fluids, with the characterizing features of claim 1, has the advantage over the prior art that the stroke of a valve element is limited to a maximum in an outwardly opening valve. According to the invention, an outwardly opening valve is provided, which has a piezoelectric actuator, for example, for actuating the valve element. The piezoelectric actuator actuates the valve element directly, i.e. in a direct, mechanical fashion, so that the stroke of the valve element is controlled. According to the invention, a stop is also provided in order to limit the stroke of the valve element. As a result, according to the invention, the tolerances in the valve can be reduced to thermally or mechanically induced tolerances comprised of pressure influence and longitudinal expansions. The sum of these tolerances is less than a stroke tolerance of the piezoelectric actuator without a stop. The invention consequently permits particularly precise injection processes, particularly in a fuel injection, wherein the injection quantities, the jet angles, and the penetration can be precisely maintained. This has a positive influence on the combustion process. Furthermore, the invention can even minimize a dynamic influence. The possibility of also using an outwardly opening valve to inject at an angle into a combustion chamber makes it possible to also use the valve according to the invention for motors in which, for space reasons, the injection valve cannot be installed in the middle of the cylinder head. Furthermore, by placing the stop in various positions, the penetration and jet shape of the injection pattern can be adapted to different combustion chambers and different motors.

In order to produce the simplest possible design, the stop is preferably embodied as a mechanical stop. It is particularly preferable for the mechanical stop to be comprised of an adjusting ring and a clamping piece for fixing the position of the adjusting ring.

In order to have a definite contact point on the valve element, the valve element preferably has a shoulder against which the adjusting ring rests.

According to another preferred embodiment of the current invention, the adjusting ring and the clamping piece are embodied of one piece in order to reduce the number of parts.

The adjusting ring preferably has a projection in order to establish the maximal stroke of the valve element.

It is particularly preferable for the valve element to be embodied as a valve needle. In order to prevent the valve needle from tilting, it is preferably doubly guided in the valve body.

According to another preferred embodiment of the current invention, the valve element is comprised of two parts: a valve needle and a pressure pin. The pressure pin is directly connected to the piezoelectric actuator for actuating the valve element.

In order to permit a secure connection between the mechanical stop and the valve element, the clamping piece of the stop is preferably welded to the valve element.

According to another different embodiment of the current invention, the stop device is embodied as a hydraulic stop. This permits a different maximal stroke of the valve element to be set in a simple manner, for example by setting different fluid filling levels of the hydraulic stop chamber. This permits a particularly simple adaptation of the valve to different combustion chambers and motors.

It is particularly preferable for the valve according to the invention to be used as a fuel injection valve in a reservoir injection system.

According to the invention, therefore, a valve is produced in which a stroke limiting stop is provided, which can be adapted with particular ease to different combustion chambers and different motors. The stop is not embodied as adjustable; in lieu of this, the stop is adapted to the different requirements during installation. Consequently, the valve according to the invention can be embodied in a particularly compact manner and can be disposed in a wide variety of positions in an engine compartment.

### DRAWINGS

Several exemplary embodiments of the invention are shown in the drawings and will be explained in detail in the subsequent description.

FIG. 1 shows a schematic section through a fuel injection valve according to a first exemplary embodiment of the current invention,

FIG. 2 shows an enlargement of the valve shown in FIG. 1, in the region containing the stop,

FIG. 3 shows a schematic partial section through a valve according to a second exemplary embodiment of the current invention,

FIG. 4 shows a schematic partial section through a valve according to a third exemplary embodiment of the current invention, and

FIG. 5 shows a schematic partial section through a valve according to a fourth exemplary embodiment of the current invention.

### DESCRIPTION OF THE EXEMPLARY EMBODIMENTS

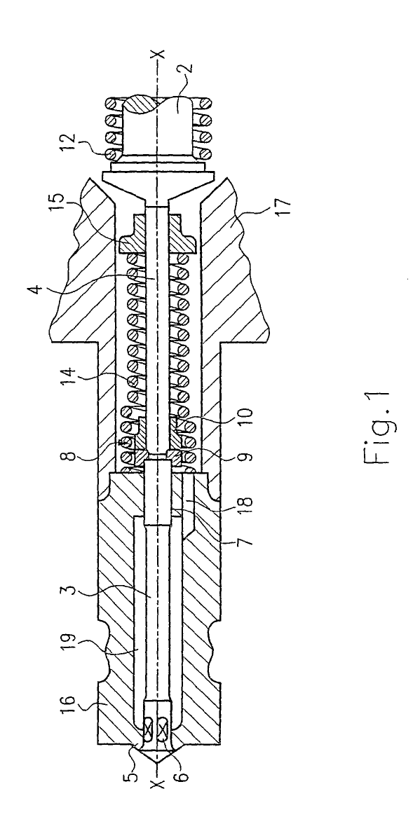

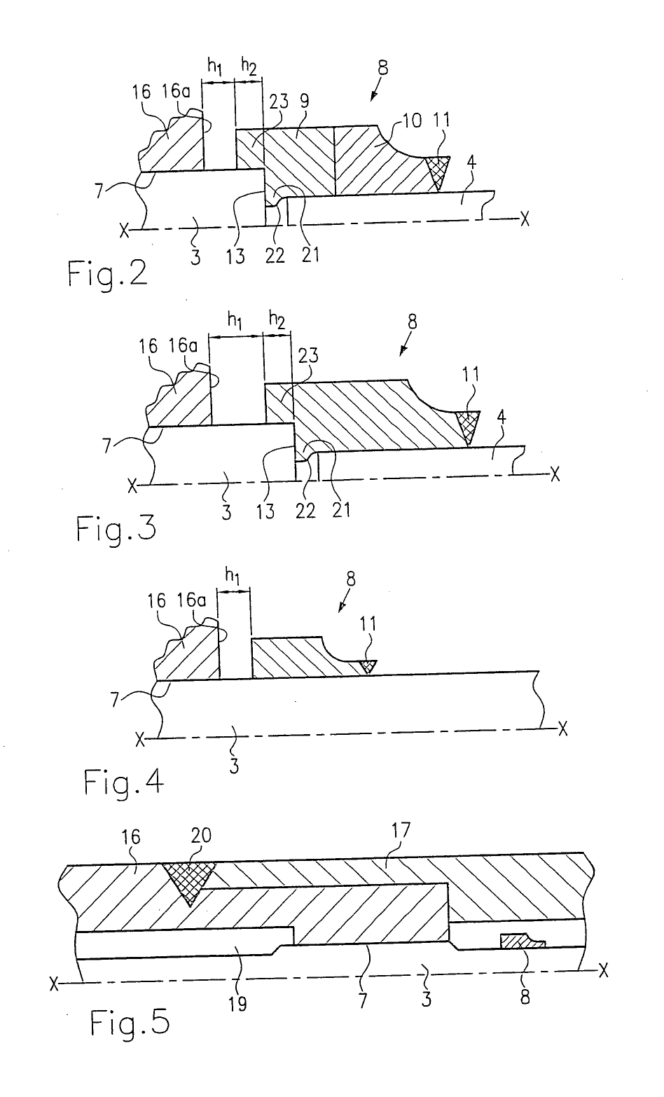

FIGS. 1 and 2 show a fuel injection valve 1 according to a first exemplary embodiment of the current invention.

As shown in FIG. 1, the valve 1 has a piezoelectric actuator, not shown, and a valve needle 3. The valve needle 3 is directly connected to a foot 2 of the piezoelectric actuator by means of a pressure pin 4, thus producing a so-called stroke control of the valve 1 in which the piezoelectric actuator mechanically actuates the valve element 3 directly. As shown in FIG. 1, the foot of the piezoelectric actuator is placed against the pressure pin 4 by means of a spring element 12, thus producing a positive engagement.

The valve needle 3 is disposed in a valve body 16, which is connected to a valve holder 17. As shown in FIG. 1, the valve 1 is an outwardly opening valve in which the valve needle 3 is moved out of the valve body 16 when actuated. When it is not actuated, the valve needle 3 closes a valve seat 5. A first valve guide 6 and a second valve guide 7 are provided in order to prevent the valve needle 3 from tilting. The first valve guide 6 is comprised of several rib-like protrusions, which slide against the valve body 16 and have openings between them.

In addition, a spring clamping piece 15 is fastened to the pressure pin 4 and serves as a spring seat for a return spring 14. At its other end, return spring 14 is supported against the valve body 16. Fuel is supplied through an inlet conduit 18 to an annular gap 19 disposed around the valve needle 3.

According to the invention, a stop 8 is also provided, which as shown in FIG. 2 in particular, includes an adjusting ring 9 and a clamping piece 10. The clamping piece 10 is affixed to the pressure pin 4 by means of a welding seam 11. The adjusting ring 9 rests against a shoulder 13 of the valve needle 3 and has an annular projection 21, which in the transition the region between the valve needle 3 and the pressure pin 4, protrudes into a recess 22 embodied in the pressure pin. In addition, the adjusting ring 9 has a projection 23 with a length h₂. Consequently, the adjusting ring 9 embraces the end of the valve needle 3 oriented away from the valve seat 15.

FIG. 2 also shows the maximal stroke height h₁. The maximal stroke height h₁ of the valve is determined by the distance between the adjusting ring 9 and the end of the stop surface 16a on the valve body 16.

The assembly of the valve 1 according to the invention occurs in such a way that first, the valve needle 3 is inserted into the valve body 16 from the front. Then, the distance between the actuator end 16a of the valve body 16 and shoulder 13 of the valve needle 3 is measured. Depending on this distance between the shoulder 13 and the valve body 16, a suitable adjusting ring 9 with a suitable projection h₂ is selected to produce a desired maximal stroke h₁. The adjusting ring 9 is slid onto the valve needle 3 from the rear until it rests against the shoulder 13 on the valve needle 3. Then, the clamping piece 10 is slid on from the rear and is connected to the pressure pin 4 by means of welding.

Then the return spring 14 and the spring clamping piece 15 are slid onto the needle and the return spring 14 is prestressed to a desired prestressing force by means of the spring clamping piece 15. The spring clamping piece 15 is attached to the pressure pin 4 by means of welding, for example. Then the valve holder 17 is slid onto the valve body 16 and the two are connected to each other by means of welding, for example. The weld between the valve body 16 and the valve holder 17 is disposed at a point, which is as far as possible from the needle guide 7. This prevents a negative effect due to a possible welding-induced distortion.

The operation of the valve according to invention will be described below. When an injection is to be executed, the piezoelectric actuator is activated, causing it to expand counter to the spring force of the spring 12, in the direction of a center line x-x of the valve. This stroke of the piezoelectric actuator is transmitted to the valve needle 3 by means of the actuator foot and the pressure pin 4. The pressure pin 4 and the valve needle 3 are attached to each other. As a result, the valve needle 3 lifts away from its valve seat 5 so that an injection of fuel occurs. The maximal stroke h₁ of the valve needle 3 is established by the mechanical stop 8, which is affixed to the pressure pin 4. Then if length changes of the individual components occur, for example due to temperature changes, the stop 8 prevents this from causing changes in the opening at the valve seat 5 that is unblocked by the valve needle 3. This keeps the injection quantity constant during operation and prevents the jet angle and the penetration from being influenced, which is necessary particularly in jet-controlled combustion processes.

When the injection is to be terminated, the piezoelectric actuator is triggered again so that it shortens. Then by means of the spring clamping piece 15 and the pressure pin 4, the return spring 14 presses the valve needle 3 back into its starting position and closes the valve seat 5. This terminates the injection.

FIG. 3 shows a valve according to a second exemplary embodiment of the current invention. Parts that are the same or function in the same manner are provided with the same reference numerals as in the first exemplary embodiment.

In contrast to the first exemplary embodiment, in the second exemplary embodiment shown in FIG. 3, the stop 8 is embodied of one piece. In other words, in lieu of the adjusting ring 9 and the clamping piece 10 in the first exemplary embodiment, only an annular stop 8 is provided. The length of the stop 8, in particular the length h₂ of the projection beyond the shoulder 13 of the valve needle 3, determines the maximal stroke height h₁. In order to permit the achievement of different maximal stroke heights h₁, it is necessary to produce a number of annular stops 8 with different-sized projections h₂. Otherwise, the second exemplary embodiment corresponds to the first exemplary embodiment so that reference can be made to description given there.

FIG. 4 shows a valve 1 according to a third exemplary embodiment of the current invention. Parts that are the same or function in the same manner are provided with the same reference numerals as in the first and second exemplary embodiment.

In contrast to the preceding exemplary embodiments, in FIG. 4, no shoulder is provided on the valve needle 3. The maximal stroke h₁ of the valve is determined, for example, by means of a feeler gage and then the stop 8 is attached to the valve needle 3 by means of welding, for example. The feeler gage is withdrawn again after the welding. As shown in FIG. 4, the stop 8 is once again embodied of one piece as in the second exemplary embodiment. Consequently, various maximal strokes h₁ can be set in different valves by keeping different feeler gages on hand.

FIG. 5 shows a fourth exemplary embodiment according to the current invention. Parts that are the same or function in the same manner are provided with the same reference numerals as in the preceding exemplary embodiments.

The fourth exemplary embodiment essentially corresponds to the third exemplary embodiment in which no shoulder is provided on the valve needle 3. FIG. 5, however, shows the connection between the valve body 16 and valve holder 17 in more detail. As shown in FIG. 5, the valve body 16 and the valve holder 17 are attached to each other by means of a welding seam 20. It should be noted that a connection between the valve body 16 and the valve 17 could also be produced by means of a thread.

Consequently, the current invention relates to a valve 1 for controlling fluids, which has a piezoelectric actuator for actuating a valve element 3, 4, wherein the valve element 3, 4 moves out of a valve body 16 when actuated. A stroke control is embodied between the piezoelectric actuator and the valve element 3, 4. The valve also includes a stop device 8 in order to limit the stroke h₁ of the valve element 3, 4.

The foregoing description of exemplary embodiment according to the current invention is solely intended for illustrative purposes and is not intended to limit the invention. Various changes and modifications are possible without going beyond the scope of the invention and its equivalents.

1. A valve for controlling fluids, which has a piezoelectric actuator for actuating a valve element (3, 4), wherein the valve element (3, 4) moves out of a valve body (16) when actuated, characterized in that a stroke control is embodied between the piezoelectric actuator and the valve element (3 ,4) and that the valve also has a stop device (8) for limiting the stroke (h₁) of the valve element (3, 4).

2. The valve according to claim 1, characterized in that the stop device (8) is embodied as a mechanical stop.

3. The valve according to claim 1 or 2, characterized in that the valve element (3) has a shoulder (13) against which the stop device (8) rests.

4. The valve according to one of claims 2 or 3, characterized in that the mechanical stop (8) is embodied of one piece.

5. The valve according to claim 2 or 3, characterized in that the mechanical stop is comprised of an adjusting ring (9) and a clamping piece (10).

6. The valve according to one of claims 1 to 5, characterized in that the mechanical stop (8) has a projecting region (23) with a length (h₂), and the maximal stroke (h₁) of the valve element (3) is determined by the projecting region (23).

7. The valve according to one of claims 1 to 6, characterized in that the valve element is embodied as a valve needle (3).

8. The valve according to claim 7, characterized in that a pressure pin (4) is disposed between the valve needle (3) and the piezoelectric actuator.

9. The valve according to one of claims 1 to 8, characterized in that the mechanical stop (8) is welded to the valve element (3, 4).

10. The valve according to claim 1, characterized in that the stop device is embodied as a hydraulic stop.
